(19) United States
(12) Patent Application Publication
(10) Pub. No.: US 2008/0101485 A1
(43) Pub. Date: May 1, 2008

(54) Receiver and transmitter in a telecommunication system

(75) Inventor: Ludwig Schwoerer, Hattingen (DE)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 11/654,572

(22) Filed: Jan. 18, 2007

(30) Foreign Application Priority Data
Oct. 26, 2006 (EP) 06 022 392.2

(51) Int. Cl. H04K 1/10

(52) U.S. Cl. 375/260

(57) ABSTRACT

In telecommunication systems, in particular OFDM telecommunication systems, there is a Fourier transformer for transforming the data signal from time to frequency domain. The present invention proposes to define the bit-reversed output of the Fourier transformer at least as a part of a deinterleaving process in a receiver. In a transmitter, the bit-reversed input of the inverse Fourier transformer is used accordingly.

### FIELD OF THE INVENTION

The present invention relates to a receiver for receiving data signals in a telecommunication system, in particular in an OFDM telecommunication system, comprising a Fourier transformer for transforming a received data signal from time domain to frequency domain, said Fourier transformer having a bit-reversed output, and a method for processing a received data signal in a telecommunication system, in particular in an OFDM telecommunication system, comprising a Fourier transformation process for transforming the received data signal from time domain to frequency domain, said Fourier transformation process including the step to generate a bit-reversed output signal. Further, the present invention relates to a transmitter for transmitting a data signal in a telecommunication system, in particular an OFDM telecommunication system, comprising an inverse Fourier transformer for transforming the data signal to be transmitted from frequency domain to time domain, said inverse Fourier transformer having a bit-reversed input, and a method for transmitting a data signal in a telecommunication system, in particular an OFDM telecommunication system, comprising an inversed Fourier transformation process for transforming the data signal to be transmitted from frequency domain to time domain, said inverse Fourier transformation process being carried out in an inverse Fourier transformer having a bit-reversed input, and further including the step to input the data signal to be transmitted into said bit-reversed input. Moreover, the present invention relates to a telecommunication system including at least such a transmitter and at least such a receiver, and further a method for processing a data signal to be transmitted by such a transmitter and to be received by such a receiver.

### BACKGROUND OF THE INVENTION

In particular in orthogonal frequency division multiplexing (OFDM) systems, Fast Fourier transformation (FFT) is used for transforming data signal between frequency and time domain. Concretely, in a receiver a Fast Fourier transformation process is carried out for transforming the received signal from time to frequency domain. In order to exploit frequency diversity, in the receiver typically a deinterleaver is provided between the FFT stage and an forward error correction (FEC) stage. Correspondingly, in the transmitter an inverse Fast Fourier transformation (IFFT) process is carried out for transforming the signal to be transmitted from frequency to time domain. Further, as a counterpart of the deinterleaving process of the receiver, in the transmitter an interleaving process is carried out before the IFFT process.

Typically, OFDM systems are designed under the assumption that the FFT and IFFT stages operate in an ideal way and therefore a linear output order is generated by the FFT stage. However, in practice this is unfortunately not the case; rather, a FFT stage in a real implementation does not produce a linear output order. Therefore, the implementation of a reordering process is required which assures that the data signal outputted by the FFT process is arranged in a linear order. Typically, such a reordering process is a subcarrier-reordering process. So, in the conventional receiver a reordering stage is provided behind the FFT stage and before the deinterleaving stage. Correspondingly, in the conventional transmitter an ordering stage is provided behind the interleaving stage and before the IFFT stage.

In the receiver, sometimes it happens that a group of consecutive subcarriers in the linear order of subcarriers outputted by the reordering stage are defective or faulty due to certain reasons like e.g. bad quality of reception. The FEC stage which is provided to correct errors in the received data signal has a problem to process such a group of consecutive defective or faulty subcarriers. In order to avoid this and to enable the FEC stage to process the defective or faulty subcarriers of such a group, the deinterleaving process is useful which is carried out before the FEC process and causes a change of the order of the subcarriers to a non-linear order in accordance with a predetermined deinterleaving scheme, usually block-wise, so that consecutive subcarriers according to a linear order each are separated with other subcarriers being placed thereinbetween.

Both the reordering and deinterleaving processes are implemented in the receiver according to standard.

However, it has been found that the reordering process consumes both memory capacity and time, i.e. latency. The same applies to the deinterleaving process which again consumes additional memory capacity and time, i.e. latency. In particular, latency tends to be a very critical parameter for many new transmission systems since it directly determines and affects power-saving (shut-down) possibilities.

### SUMMARY OF THE INVENTION

It is an object of the present invention to avoid the aforementioned problems and to simplify the construction of a receiver and a transmitter of the above kind.

In order to achieve the above and further objects, in accordance with a first aspect of the present invention, there is provided a receiver for receiving data signals in a telecommunication system, in particular in an OFDM telecommunication system, comprising a Fourier transformer for transforming a received data signal from time domain to frequency domain, said Fourier transformer having a bit-reversed output, wherein the bit-reversed output of the Fourier transformer is provided to be used as deinterleaver output.

In accordance with a second aspect of the present invention, there is provided a method for processing a received data signal in a telecommunication system, in particular in an OFDM telecommunication system, comprising a Fourier transformation process for transforming the received data signal from time domain to frequency domain, said Fourier transformation process including the step to generate a bit-reversed output data signal, wherein said bit-reversed output data signal is used as deinterleaver output data signal.

In accordance with a third aspect of the present invention, there is provided a transmitter for transmitting a data signal in a telecommunication system, in particular in an OFDM telecommunication system, comprising an inverse Fourier transformer for transforming the data signal to be transmitted from frequency domain to time domain, said inverse Fourier transformer having a bit-reversed intput, wherein the bit-reversed input of the inverse Fourier transformer is provided to be used as interleaver input.

In accordance with a fourth aspect of the present invention, there is provided a method for transmitting a data signal in a telecommunication system, in particular an OFDM telecommunication system, comprising an inversed Fourier transformation process for transforming the data signal to be transmitted from frequency domain to time domain, said inverse Fourier transformation process being carried out in an inverse Fourier transformer having a bit-reversed input, and further including the step to input the data signal to be transmitted into said bit-reversed input, wherein said bit-reversed input of the inverse Fourier transformer is used as interleaver input.

In accordance with a fifth aspect of the present invention, there is provided a telecommunication system including at least one receiver according to the first aspect and at least one transmitter according to the third aspect.

In accordance with a sixth aspect of the present invention, there is provided a method in a telecommunication system comprising a method according to the second aspect and a method according to the fourth aspect.

Accordingly, the present invention proposes to use in the receiver the existing bit-reversed output of the Fourier transformer as deinterleaver output and, thus, to define the bit-reversed order of the data signal outputted by the Fourier transformation at least as part of the result of a deinterleaving process. The same applies to the transmitter wherein the bit-reversed input of the inverse Fourier transformer is used as an interleaver input so as to define the bit-reversed order of the data signal to be transmitted and inputted into the inverse Fourier transformer at least as part of the result of an interleaving process. So, the present invention renders the implementation of both the reordering and deinterleaving in the receiver and of both the interleaving and ordering in the transmitter superfluous.

Accordingly, in the receiver both the reordering and deinterleaving stages can be omitted and therefore memories for these stages are not required anymore. The same applies with regard to the interleaving and ordering stages in the transmitter. This again results in a drastical reduction of latency.

Although according to the present invention the deinterleaving can be omitted in the receiver, this will not cause problems in the FEC of the aforementioned kind. Namely, the bit-reversed output of the Fourier transformer produces a non-linear order of subcarriers wherein consecutive subcarriers according to a linear order each are separated. So, it has been found that the situation at the bit-reversed output of the Fourier transformer is similar to that at a deinterleaver output and therefore is also useful for a subsequent forward error correction.

After all, an advantage of the present invention lies in a reduction of memory requirements and latency, which reduction even might be drastical in some cases and results in an increase of the processing speed. Further, the present invention leads to a simplification of the construction of the receiver and the transmitter. So, the present invention is suitable for existing as well as for new transmission systems, in particular OFDM systems like according to the 3.9G standard.

The scheme according to the present invention can be implemented in either hardware or software, depending on the throughput requirements of the rest of the system.

Further advantageous embodiments are defined in the dependent claims.

### BRIEF DESCRIPTION OF THE DRAWINGS

In the following, the present invention will be described in greater detail based on a preferred embodiment with reference to the accompanying drawings, in which:

FIG. 1 shows a schematic block diagram of the traditional architecture of a receiver used in OFDM systems, and the sequence of subcarriers at different locations;

FIG. 2 shows a schematic block diagram of the traditional architecture of a transmitter used in OFDM systems;

FIG. 3 shows a schematic block diagram of an architecture of a receiver used in OFDM systems which architecture is modified over that shown in FIG. 1 in accordance with a preferred embodiment of the present invention, and the sequence of subcarriers at a certain location; and

FIG. 4 shows a schematic block diagram of an architecture of a transmitter used in OFDM systems which architecture is modified over that shown in FIG. 2 in accordance with a preferred embodiment of the present invention.

### DESCRIPTION OF THE PREFERRED EMBODIMENT

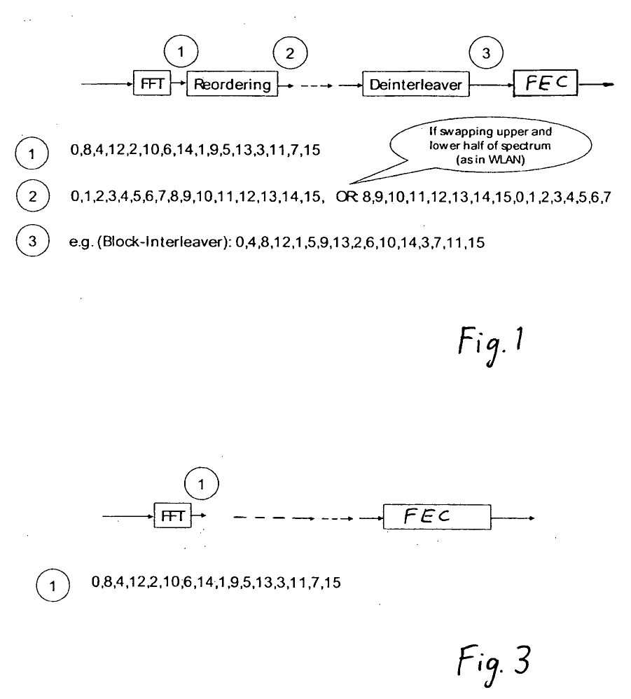

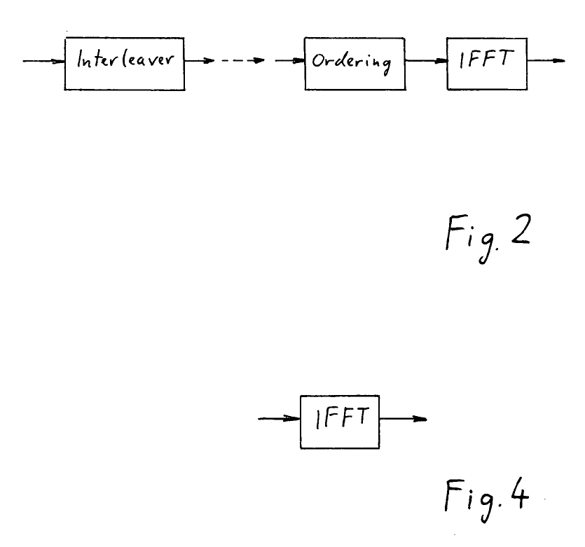

For a better understanding of the present invention, at first the traditional architecture is described with reference to FIGS. 1 and 2 before a preferred embodiment of the present invention will be described with reference to FIGS. 3 and 4 in comparison with the FIGS. 1 and 2.

FIG. 1 shows as an example a schematic block diagram of the traditional architecture of a receiver used in an OFDM system with a fast Fourier transformation FFT size of 16. Further shown are the sequences of subcarriers of the received data signal at different locations in the receiver.

As shown in FIG. 1, the receiver comprises a fast Fourier transformation stage FFT wherein the received digital data signal is transformed from time to frequency domain. The output of the FFT stage (at position 1 in FIG. 1) is a bit-reversed output where the frequency domain signal comprises the following order of subcarriers:
0, 8, 4, 12, 2, 10, 6, 14, 1, 9, 5, 13, 3, 11, 7, 15.

This data signal is inputted into a reordering stage which changes the order of the data signal to a linear order so that the data signal at the output of the reordering stage (at position 2 in FIG. 1) has a format like
0, 1, 2, 3, 4, 5, 6, 7, 8, 9, 10, 11, 12, 13, 14, 15
   or in case of swapping the upper and lower half of the spectrum (as in e.g. wireless local area network systems) like
8, 9, 10, 11, 12, 13, 14, 15, 0, 1, 2, 3, 4, 5, 6, 7.

Such a reordering is utilized since in real implementation the FFT stage is not able to create a linear output order.

The data signal processed in the reordering stage is transferred to a deinterleaving stage or deinterleaver. Between the reordering stage and the deinterleaving stage there might be some additional stages for further processing the data signal which however are not of particular interest here.

In the deinterleaving stage the order of the subcarriers is again changed to a non-linear order in a block-wise manner in accordance with a predetermined deinterleaving scheme so that the order of the data signal at the output of the deinterleaving stage (at position 3 in FIG. 1) looks like e.g.
0, 4, 8, 12, 1, 5, 9, 13, 2, 6, 10, 14, 3, 7, 11, 15.

Then, the data signal processed in the deinterleaving stage is transferred to a forward error correction stage FEC wherein errors which might occur in the data signal are eliminated. Usually, the FEC stage has a problem to process defective of faulty subcarriers forming a group of consecutive subcarriers according to a linear order like e.g. “0, 1, 2”. However, this problem is avoided by the deinterleaving process where such a group is split by separating its consecutive subcarriers and taking them to different positions within the data signal with other bits being putted thereinbetween.

FIG. 2 shows a schematic block diagram of the traditional architecture of a transmitter used in OFDM systems which architecture comprises similar stages as the receiver of FIG. 1 but with reversed functions and in a reversed order. So, the frequency domain data signal to be transmitted is inputted into an interleaving stage or interleaver. Then, the data signal processed by the interleaving stage is transferred to an ordering stage so as to get a certain order which is suitable for processing in a subsequent inverse fast Fourier transforming stage IFFT. In the IFFT stage the data signal is transformed from frequency to time domain, and then the time-domain signal is transmitted. Between the interleaving stage and the ordering stage there might be some additional stages for further processing the data signal which however are not of particular interest here.

FIG. 3 shows a schematic block diagram of a new architecture of the receiver to be used in OFDM systems in accordance with a preferred embodiment of the present invention. Here again as an example a FFT size of 16 is used. Further shown in FIG. 3 is the sequence of subcarriers at a certain location in this receiver.

In the new architecture of FIG. 3, the bit-reversed output order of the FFT stage is defined as the result of at least a part of a deinterleaving process.

As it is noted by a comparison between FIGS. 1 and 3, in the new architecture of FIG. 3 the reordering and deinterleaving stages are omitted so that the bit-reversed output of the FFT stage (at position 1 in FIG. 3) is directly coupled to the input of the FEC stage, wherein between the FFT and the FEC stages there might be some additional stages for further processing the data signal which however are not of interest here. So, the FEC stage considers the bit-reversed output of the FFT stage as deinterleaver output like in the traditional architecture of FIG. 1. In other words, the output at position 1 is directly taken to the deinterleaver output at position 3 of FIG. 1.

Accordingly, the output signal of the FFT stage having the order of subcarriers
0, 8, 4, 12, 2, 10, 6, 14, 1, 9, 5, 13, 3, 11, 7, 15
   is considered a data signal which is assumed to be already subject to a deinterleaving process although such a process has not additionally been carried out here.

Considering the afore-mentioned problem of the FEC stage regarding the processing of a group of defective or faulty subcarriers which are consecutive according to a linear order, the use of the bit-reversed output of the FFT stage as deinterleaver output has the same effect as a ‘real’ deinterleaving process. Namely, in the bit-reversed output signal of the FFT stage consecutive subcarriers according to a linear order each are separated and placed within the data signal at different locations with other subcarriers placed thereinbetween. This becomes clear with reference to the afore-mentioned example of the group of consecutive subcarriers “0, 1, 2” which are separated from each other in the bit-reversed output signal of the FFT stage.

By defining the bit-reversed output of the FFT stage at least as part of a deinterleaving process, the latency can be drastically reduced in the receiver comprising the new architecture of FIG. 3.

Although not basically necessary, in some cases a bit-deinterleaver having a smaller size than the deinterleaving stage of FIG. 1 may be provided between the FFT and FEC stages if desired.

In the transmitter, the bit-reversed input of the IFFT stage is used accordingly, as schematically shown in FIG. 4. From a comparison with FIG. 2 it is to be noted that the interleaving and ordering stages have been omitted so that the frequency-domain data signal to be inputted into the bit-reversed input of the IFFT stage is considered a signal which is assumed to be already processed by an interleaving process although such a process is not carried out.

Finally, it should be noted that the above described preferred embodiment is of a preferred example for implementing the present invention, but the scope of the present invention should not necessarily be limited by the above description. The scope of the present invention is defined by the following claims.

1. A receiver for receiving data signals in a telecommunication system, the receiver comprising:
a Fourier transformer configured to transform a received data signal from time domain to frequency domain, said Fourier transformer having a bit-reversed output,
wherein the bit-reversed output of the Fourier transformer is provided to beused as deinterleaver output.

2. The receiver according to claim 1, wherein the Fourier transformer is a Fast Fourier transformer.

3. The receiver according to claim 1, wherein the bit-reversed output of the Fourier transformer is coupled to a forward error corrector.

4. A method for processing a received data signal in a telecommunication system, the method, comprising:
transforming, by a Fourier transformation process, a received data signal from time domain to frequency domain, said Fourier transformation process including generating a bit-reversed output data signal,
wherein said bit-reversed output data signal is used as deinterleaver output data signal.

5. The method according to claim 4, wherein the Fourier transformation process is a Fast Fourier transformation process.

6. The method according to claim 4, further comprising carrying out a forward error correction process after the Fourier transformation process.

7. A transmitter for transmitting a data signal in a telecommunication system, the transmitter comprising:
an inverse Fourier transformer configured to transform a data signal to be transmitted from frequency domain to time domain, said inverse Fourier transformer having a bit-reversed intput,
wherein the bit-reversed input of the inverse Fourier transformer is provided to be used as interleaver input.

8. The transmitter according to claim 7, wherein the inverse Fourier transformer is an inverse Fast Fourier transformer.

9. A method for transmitting a data signal in a telecommunication system, the method comprising:
transforming, by an inversed Fourier transformation process, a data signal to be transmitted from frequency domain to time domain, said inverse Fourier transformation process being carried out in an inverse Fourier transformer having a bit-reversed input; and
inputting the data signal to be transmitted into said bit-reversed input,
wherein said bit-reversed input of the inverse Fourier transformer is used as interleaver input.

10. The method according to claim 9, wherein the inversed Fourier transformation process is an inverse Fast Fourier transformation process.

11. A telecommunication system, comprising:
at least one transmitter configured to transmit a data signal in the OFDM telecommunication system, the transmitter comprising an inverse Fourier transformer configured to transform a data signal to be transmitted from frequency domain to time domain, said inverse Fourier transformer having a bit-reversed intput, wherein the bit-reversed input of the inverse Fourier transformer is provided to be used as interleaver input; and
at least one receiver configured to receive data signals in the OFDM telecommunication system, the receiver comprising a Fourier transformer configured to transform a received data signal from time domain to frequency domain, said Fourier transformer having a bit-reversed output, wherein the bit-reversed output of the Fourier transformer is provided to be used as deinterleaver output.

12. A method in a telecommunication system, the method comprising:
transforming, by a Fourier transformation process, a received data signal from time domain to frequency domain, said Fourier transformation process including generating a bit-reversed output data signal, wherein said bit-reversed output data signal is used as deinterleaver output data signal; and
transforming, by an inversed Fourier transformation process, a data signal to be transmitted from frequency domain to time domain, said inverse Fourier transformation process being carried out in an inverse Fourier transformer having a bit-reversed input; and inputting the data signal to be transmitted into said bit-reversed input,
wherein said bit-reversed input of the inverse Fourier transformer is used as interleaver input.

13. The receiver according to claim 1, wherein the telecommunication system as an orthogonal frequency division multiplexing telecommunication system.

14. The method according to claim 5, wherein the telecommunication system as an orthogonal frequency division multiplexing telecommunication system.

15. The transmitter according to claim 7, wherein the telecommunication system as an orthogonal frequency division multiplexing telecommunication system.

16. The method according to claim 9, wherein the telecommunication system as an orthogonal frequency division multiplexing telecommunication system.

17. The telecommunication system according to claim 11, wherein the telecommunication system as an orthogonal frequency division multiplexing telecommunication system.

18. The method according to claim 12, wherein the telecommunication system as an orthogonal frequency division multiplexing telecommunication system.

19. An apparatus, comprising:
transforming means for transforming, by a Fourier transformation process, a received data signal from time domain to frequency domain, said Fourier transformation process including generating a bit-reversed output data signal, wherein said bit-reversed output data signal is used as deinterleaver output data signal; and
transforming means for transforming, by an inversed Fourier transformation process, a data signal to be transmitted from frequency domain to time domain, said inverse Fourier transformation process being carried out in an inverse Fourier transformer having a bit-reversed input; and inputting the data signal to be transmitted into said bit-reversed input,
wherein said bit-reversed input of the inverse Fourier transformer is used as interleaver input.
